(19) United States
(12) Patent Application Publication
(10) Pub. No.: US 2020/0177803 A1
(43) Pub. Date: Jun. 4, 2020

(54) IMAGING APPARATUS, CONTROL METHOD, AND PROGRAM

(71) Applicant: CANON KABUSHIKI KAISHA, Tokyo (JP)

(72) Inventor: Wataru Honjo, Tokyo (JP)

(21) Appl. No.: 16/696,215

(22) Filed: Nov. 26, 2019

(30) Foreign Application Priority Data
Dec. 4, 2018 (JP) 2018-227325

(51) Int. Cl. H04N 5/232

(52) U.S. Cl. CPC H04N 5/23225; H04N 5/23299; H04N 5/23296; H04N 5/23203

(57) ABSTRACT

An imaging apparatus includes a storage unit that stores a profile that is referred to in control of the imaging apparatus and that includes an area type of a captured image to be controlled; a transmitting unit that transmits a setting value that is involved in a process to change an area of the captured image and that does not depend on a method for the changing process and an identifier for identifying the setting value to an external apparatus; a receiving unit that receives an instruction to add the setting value to the profile with the identifier of the setting value from the external apparatus; and an adding unit that adds the setting value indicated in the adding instruction to the profile.

### BACKGROUND OF THE INVENTION

### Field of the Invention

The present disclosure relates to an imaging apparatus, a control method, and a program.

### Description of the Related Art

In monitoring cameras, update of an imaging area through operation of a pan mechanism, a tilt mechanism, and a zoom mechanism (hereinafter referred to as PTZ) of the camera has hitherto been performed. In Open Network Video Interface Forum (hereinafter referred to as ONVIF), which is a common standard involved in connection between a network camera and a client device, PTZ_Service is standardized. PTZ_Service is a group of commands for, for example, change and acquisition of the imaging area.

In ONVIF, PTZ settings (PTZconfiguration) are defined as setting values of the monitoring camera. Here, the PTZ settings are settings of PTZ control of the monitoring camera. Video source settings (Video Source Configuration) and video encoder settings (Video Encoder Configuration) are further defined in the ONVIF. The video source settings include information about the presence and the kind of cropped areas and the setting of resolution which a sensor is capable of outputting. The video encoder settings include the encoding type of encoding of images and the setting of resolution. These settings are added to a profile (Profile) specified in control the monitoring camera and the monitoring camera controls delivery of videos and the imaging area in accordance with the settings added to the profile.

FIG. 8 illustrates how the settings are added to the profile in the ONVIF standard. One setting is selected from each of one or more video source settings, one or more video encoder settings, and one or more PTZ settings and the selected settings are added to the profile. Although the multiple settings are included in one profile, as described above, one setting may have dependency relationship with the other settings. In order to prevent an occurrence of mismatch when only one of the resolution of image data and the resolution of a delivered image that is compressed and encoded is updated, a technology to adjust the setting values of the video source settings and the video encoder settings is disclosed (Japanese Patent Laid-Open No. 2014-107590).

In high-pixel cameras including 360-degree cameras, an image that is capable of being captured by the camera may be partially cropped and the image of the cropped area may be transmitted to a client apparatus. In this case, update of an entire image of the captured image is realized through mechanical pan-tilt-zoom (PTZ) control while update of the cropped image is realized with a digital PTZ function. When the monitoring camera has the mechanical PTZ mechanism and the digital PTZ function described above, either of the settings for control of the mechanical PTZ mechanism and the settings for the digital PTZ function are set in the profile as the PTZ settings (PTZConfiguration). In this case, the dependency relationship is established between the video source settings and the PTZ settings. It is necessary to add the PTZ settings for control of the mechanical PTZ mechanism to the video source settings of the entire image while it is necessary to add the PTZ settings for the digital PTZ function to the video source settings of the cropped image.

However, since a user is not capable of understanding the dependency relationship between the video source settings and the PTZ settings, the user may add a combination of the video source settings and the PTZ settings that are not associated with each other to the profile. In this case, there is an issue in that the PTZ control that is not associated with the images is performed in the monitoring camera.

### SUMMARY OF THE INVENTION

The present disclosure provides, for example, the following configuration in order to provide a mechanism capable of adding appropriate settings to the profile without an awareness of the dependency relationship between the video source settings and the PTZ settings by the user.

An imaging apparatus includes a storage unit that stores a profile that is referred to in control of the imaging apparatus and that includes an area type of a captured image to be controlled; a transmitting unit that transmits a setting value that is involved in a process to change an area of the captured image and that does not depend on a method for the changing process and an identifier for identifying the setting value to an external apparatus; a receiving unit that receives an instruction to add the setting value to the profile with the identifier of the setting value from the external apparatus; and an adding unit that adds the setting value indicated in the adding instruction to the profile.

Further features of the present invention will become apparent from the following description of exemplary embodiments with reference to the attached drawings.

### BRIEF DESCRIPTION OF THE DRAWINGS

FIG. 1 is an overall view of an imaging system.

FIG. 2 is a hardware configuration diagram of a camera.

FIG. 3 is a hardware configuration diagram of a client apparatus.

FIG. 4 is a flowchart illustrating a PTZ setting process.

FIG. 5 is a flowchart illustrating a PTZ control process.

FIG. 6 is a flowchart illustrating a preset registration process.

FIG. 7 is a flowchart illustrating a preset read-out process.

FIG. 8 is an explanatory diagram of related art.

### DESCRIPTION OF THE EMBODIMENTS

Embodiments of the present invention will herein be described with reference to the drawings.

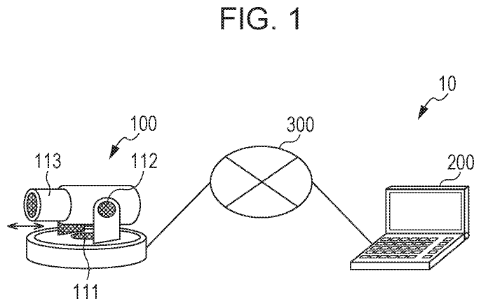

FIG. 1 is an overall view of an imaging system 10. The imaging system 10 includes a camera 100 and a client apparatus 200. The camera 100 is an example of an imaging apparatus. The client apparatus 200 is an example of an external apparatus. The camera 100 and the client apparatus 200 are connected to each other via a network 300 so as to be communicable with each other.

The camera 100 includes a pan mechanism 111, a tilt mechanism 112, and a zoom mechanism 113. The pan mechanism 111, the tilt mechanism 112, and the zoom mechanism 113 are mechanisms to change the orientation of the lens to a pan direction, a tilt direction, and a zoom direction, respectively. The camera 100 transmits various commands for, for example, PTZ control to the client apparatus 200 and transmits responses to the commands, an image that is captured, and so on to the client apparatus 200.

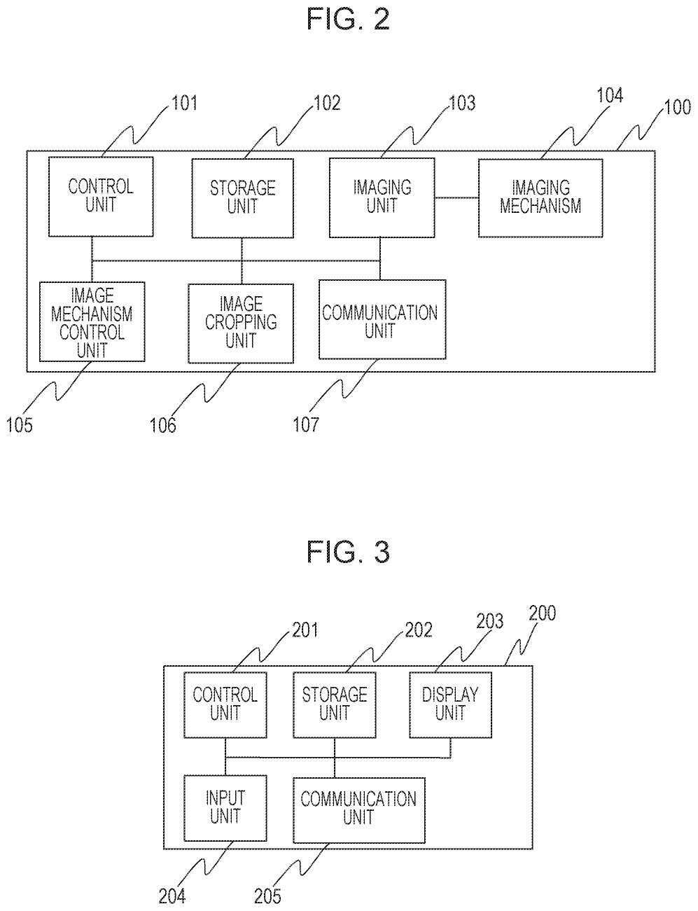

FIG. 2 is a hardware configuration diagram of the camera 100. Referring to FIG. 2, the camera 100 includes a control unit 101, a storage unit 102, an imaging unit 103, an imaging mechanism 104, an image mechanism control unit 105, an image cropping unit 106, and a communication unit 107. The control unit 101 controls the entire camera 100. The control unit 101 is composed of, for example, a central processing unit (CPU). The storage unit 102 is mainly used as a storage area of programs executed by the control unit 101 and a working area during execution of the programs. The storage unit 102 is also used as a storage and temporary storage area of captured image data generated by the imaging unit 103 described below and cropped image data generated by the image cropping unit 106 described below. The storage unit 102 is also used as a storage area of a variety of data, such as the direction of the imaging mechanism 104, which is controlled in the image mechanism control unit 105 described below, and the setting values of the cropped area of a cropped image, which are controlled in the image cropping unit 106 described below. The functions of the camera 100 and the processes in the camera 100 described below are realized by the control unit 101, which reads out the programs stored in the storage unit 102 and executes the programs that are read out.

The imaging unit 103 converts an analog signal acquired from an image of an object, which is formed by the imaging mechanism 104 described below, into digital data and supplies the digital data to the storage unit 102 as a captured image. The imaging mechanism 104 includes an imaging optical system composed of, for example, a lens and an imaging device. The imaging mechanism 104 further includes the pan mechanism 111, the tilt mechanism 112, and the zoom mechanism 113. The image mechanism control unit 105 controls the pan mechanism 111, the tilt mechanism 112, and the zoom mechanism 113. The image mechanism control unit 105 performs mechanical PTZ control and, then, supplies the values indicating the position, the range, and so on involved in an imaging area that is changed through the control to the storage unit 102.

The image cropping unit 106 is a CPU or a graphics processing unit (GPU). The image cropping unit 106 partially crops an area of the captured image acquired by the imaging unit 103 and supplies the cropped area to the storage unit 102. The area that is to be cropped from the captured image is specified by a command that is received from the client apparatus 200 via the communication unit 107 and that controls the imaging area. After the cropping of the image, the image cropping unit 106 supplies the values indicating the position, the range, and so on involved in the cropped area to the storage unit 102. The communication unit 107 transmits and receives a variety of information to and from the client apparatus 200 via the network 300.

As another example, at least part of the functions of the camera 100 and the processes in the camera 100 may be realized by cooperation between, for example, the CPU, a random access memory (RAM), a read only memory (ROM), and a storage. As another example, at least part of the functions of the camera 100 and the processes in the camera 100 may be realized using a hardware circuit. As another example, the processing in the image mechanism control unit 105 may be performed by the control unit 101. As another example, the processing in the image cropping unit 106 may be performed by the control unit 101. In addition, the camera 100 may additionally include a vide analysis unit, an audio input unit, and an audio output unit.

FIG. 3 is a hardware configuration diagram of the client apparatus 200. Referring to FIG. 3, the client apparatus 200 includes a control unit 201, a storage unit 202, a display unit 203, an input unit 204, and a communication unit 205. The control unit 201 is composed of, for example, a CPU and controls the entire client apparatus 200. The storage unit 202 is mainly used as a storage area of programs executed by the control unit 201, a working area during execution of the programs, and a storage area of a variety of data, such as information about the camera that currently exists on the network 300 and that is capable of being connected to the client apparatus 200.

The display unit 203 is composed of, for example, a liquid crystal display (LCD) or an organic electro luminescence (EL) display and displays various setup screens, a data acquisition-display screen, a viewer of videos received from the camera 100, various messages, and so on to a user of the client apparatus 200. The input unit 204 is composed of, for example, buttons, arrow keys, a touch panel, and/or a mouse and notifies the control unit 201 of the content of a screen operation by the user. The communication unit 205 transmits and receives a variety of information to and from the camera 100 via the network 300. The client apparatus 200 may further include an image analysis unit, a video accumulation unit, and so on.

The PTZ control by the camera 100 will now be described. The camera 100 of the present embodiment is capable of transmitting not only the captured image acquired by the imaging unit 103 but also the image partially cropped from the captured image to the client apparatus 200. The captured image acquired by the imaging unit 103 is hereinafter referred to as an entire image and the image partially cropped from the captured image is hereinafter referred to as the cropped image. Accordingly, the target of the PTZ control by the camera 100 may be not only the entire image but also the cropped image.

When the control target is the entire image, the PTZ control is realized by a process to control the pan mechanism 111, the tilt mechanism 112, and the zoom mechanism 113 by the image mechanism control unit 105. The process to control the pan mechanism 111, the tilt mechanism 112, and the zoom mechanism 113 by the image mechanism control unit 105 is hereinafter referred to as mechanical PTZ control. In contrast, when the control target is the cropped image, the PTZ control is realized by a process to change the size and the position of an area cropped by the image cropping unit 106. The process to change the size and the position of an area cropped by the image cropping unit 106 is hereinafter referred to as digital PTZ control. The mechanical PTZ control is an example of a method of driving at least one driver, among PTZ drivers, to change at least one of the position and the range of the area. The digital PTZ control is an example of a method of changing at least one of the position and the range of the area through digital processing.

As described above, the process to realize the PTZ control is differentiated depending on whether the area to be controlled is the entire area of the captured image or a partial area (cropped area) thereof. The camera 100 of the present embodiment sets PTZ control values that realize the PTZ control appropriate for the type of the area to be controlled. Both the mechanical PTZ control and the digital PTZ control are exemplary methods for a changing process to change the size and the position of an area in the captured image.

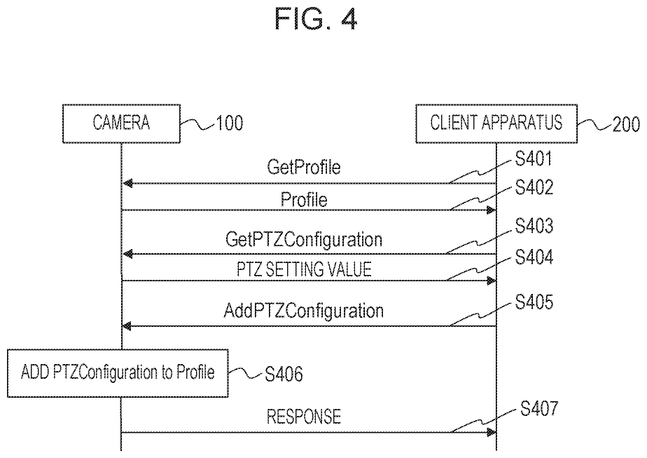

FIG. 4 is a flowchart illustrating a PTZ setting process performed by the camera 100. Setting of the PTZ is performed using ONVIF commands in the PTZ setting process. The processing by the camera 100 and the client apparatus 200 in the PTZ setting process are mainly performed by the control unit 101 and the control unit 201, respectively. Referring to FIG. 4, in S401, the client apparatus 200 transmits a GetProfile command to the camera 100 via the communication unit 205. The GetProfile command is a command to request Profile held by the camera 100. It is assumed here that multiple Profiles that are referred to in control of the camera 100 are stored in the storage unit 102 in the camera 100. Video Source Configuration indicating the type (area type) of the area to be controlled is included in each Profile. The area type is information indicating either of the entire image and the cropped image. In addition, Token for identifying each Profile is associated with the Profile.

Upon reception of the GetProfile command via the communication unit 107, in S402, the control unit 101 transmits Token for identifying Profile that is held to the client apparatus 200 via the communication unit 107 as a response. In S403, the client apparatus 200 transmits a GetPTZConfiguration command to the camera 100. The GetPTZConfiguration command is a command to inquire of the camera 100 about PTZConfiguration held by the camera 100. PTZConfiguration is a setting value involved in the changing process to change the position and the range of the area to be controlled. However, the setting value involved in the changing process is, for example, a basic working speed (DefaultSpeed) in control and a working range (Range) of a target image and does not includes information about the position and the size of the target area. As described above, in the present embodiment, the setting value of PTZConfiguration is a value that does not depend on whether the method for the changing process is the mechanical PTZ control or the digital PTZ control. PTZConfiguration is an example of the setting value that is involved in the changing process of the area and that does not depend on the method for the changing process. The camera 100 of the present embodiment stores only one PTZConfiguration.

In S404, the camera 100 transmits the setting value of PTZConfiguration and Token, which is an identifier of PTZConfiguration, which are stored in the storage unit 102, to the client apparatus 200 as a response. The camera 100 stores only one PTZConfiguration, as described above, and only one set of the setting value of PTZConfiguration and Token is transmitted in S404.

The user of the client apparatus 200 is capable of changing the setting value using a SetPTZConfiguration command when the user wants to change the setting value of PTZConfiguration. After the setting value is changed, the camera 100 stores PTZConfiguration the setting value of which is changed.

In S405, the client apparatus 200 transmits an AddPTZConfiguration command. The AddPTZConfiguration command is a command to request addition of PTZConfiguration to Profile. In other words, the AddPTZConfiguration command is an example of an adding instruction. The client apparatus 200 selects desired Profile, among Profiles acquired in S402, in accordance with the user's operation. Then, the client apparatus 200 adds Token of the selected Profile and Token of PTZConfiguration received in S404 to the AddPTZConfiguration command as parameters.

Upon reception of AddPTZConfiguration command, in S406, the camera 100 adds PTZConfiguration specified in the AddPTZConfiguration command to Profile specified in the AddPTZConfiguration command. If the addition is normally completed, in S407, the camera 100 transmits a normal completion response to the client apparatus 200. The PTZ setting process is performed in the above manner. As described above, the camera 100 transmits only one kind of Token of PTZConfiguration to the client apparatus 200 in S404. Accordingly, if the AddPTZConfiguration command to which Token of PTZConfiguration including another kind of Token is added is received, the control unit 101 transmits an error response to the client apparatus 200.

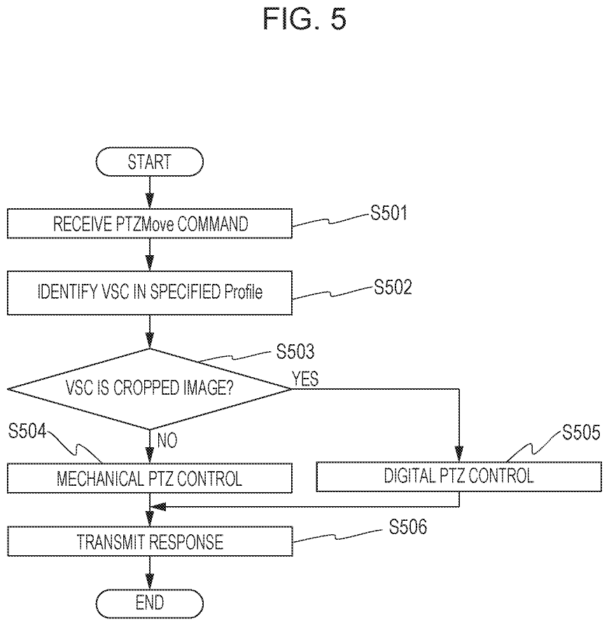

FIG. 5 is a flowchart illustrating a PTZ control process performed by the camera 100. The PTZ control process is a process to perform the PTZ control in accordance with Profile for which PTZConfiguration is set in the PTZ setting process described above with reference to FIG. 4. Referring to FIG. 5, in S501, the control unit 101 in the camera 100 receives a PTZMove command from the client apparatus 200. The PTZMove command is a command to request change of at least one of the position and the range of the area to be controlled. The PTZMove command does not include information for limiting the area to be controlled to the entire image or the cropped image and the PTZMove command is capable of being used in both cases. The client apparatus 200 adds Token specifying Profile to be executed to the PTZMove command as a parameter and transmits the PTZMove command to which Token is added to the camera 100. The PTZMove command is an example of a changing instruction.

In S502, the control unit 101 in the camera 100 identifies Video Source Configuration (hereinafter referred to as VSC) included in Profile specified by Token added to the received PTZMove command. As described above, VSC indicating the area type is included in Profile, in addition to PTZConfiguration.

In S503, the control unit 101 determines whether the area type indicated in the identified VSC is the cropped image or the entire image. If the area type is not the cropped image, that is, if the area type is the entire image (NO in S503), the process goes to S504. If the area type is the cropped image (YES in S503), the process goes to S505.

In S504, the control unit 101 determines the mechanical PTZ control as the control for PTZConfiguration and performs the mechanical PTZ control. Specifically, the control unit 101 instructs the image mechanism control unit 105 to drive at least one of the pan mechanism 111, the tilt mechanism 112, and the zoom mechanism 113 in accordance with PTZConfiguration. In response to the instruction, at least one of the pan mechanism 111, the tilt mechanism 112, and the zoom mechanism 113 is driven to change the entire image. The change of the entire image includes movement of the range of the entire image and increase and reduction (rescaling) of the range.

In S505, the control unit 101 determines the digital PTZ control as the control for PTZConfiguration and performs the digital PTZ control. Specifically, the control unit 101 instructs the image cropping unit 106 to crop the image in accordance with PTZConfiguration. In response to the instruction, the image cropping unit 106 crops the cropped image corresponding to PTZConfiguration. This realizes movement of the cropped image and increase and reduction of the range. Upon completion of the change of the image, in S506, the control unit 101 stores information about the area of the image after the change in the storage unit 102 and transmits the normal completion response to the client apparatus 200. The PTZ control process is performed in the above manner.

A case in which the control unit 101 in the camera 100 receives a GetPTZPosition command will now be described. The GetPTZPosition command is a command to request acquisition of the position of the imaging area. In other words, the GetPTZPosition command is a request to acquire the position of the area. Token specifying Profile the position of which is to be acquired is added to the GetPTZPosition command as a parameter. Upon reception of the GetPTZPosition command, the camera 100 identifies VSC included in Profile added to the GetPTZPosition command. Then, the control unit 101 returns the position of the entire image if the area type indicated in the identified VSC is the entire image. The position of the entire image is identified from the PTZ values. The control unit 101 returns the position of the cropped image if the area type indicated in the identified VSC is the cropped image. The position of the cropped image is identified from the PTZ values and the cropping position (relative position) in the image.

As described above, the area type is included in Profile stored in the camera 100. The camera 100 transmits the single setting value and the identifier that are involved in the PTZ control and that do not discriminate the control type (the method for the changing process) to the client apparatus 200. The user of the client apparatus 200 is capable of adding PTZConfiguration to Profile without specification of the method for the PTZ control by specifying the single setting value. In other words, the user is capable of adding the PTZ settings to Profile without being aware of the dependency relationship between the area type and the PTZ settings.

In addition, although the information for identifying the method for the PTZ control (the mechanical PTZ control or the digital PTZ control) is not included in Profile, the area type is included in Profile. Accordingly, the camera 100 is capable of identifying the method for the PTZ control depending on whether the area type is the entire image or the cropped image.

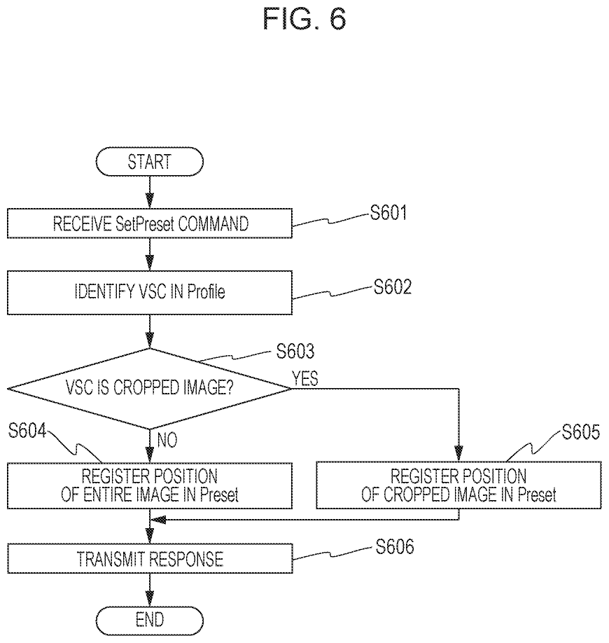

FIG. 6 is a flowchart illustrating a preset registration process performed by the camera 100. The preset registration process is a process to register the area, which is an imaging target at the time of processing, as a preset position using the ONVIF commands. Referring to FIG. 6, in S601, the control unit 101 in the camera 100 receives a SetPreset command from the client apparatus 200 via the communication unit 107. The SetPreset command is a command to request registration of the area to be controlled at the time of processing as the preset position. The client apparatus 200 transmits to the camera 100 the SetPreset command to which Token specifying Profile in which the imaging area is to be registered and Token of Preset indicating Preset to be registered are added. The SetPreset command is an example of an instruction to register the preset position.

In S602, the control unit 101 identifies VSC included in Profile specified by Token of Profile included in the received SetPreset command. In S603, the control unit 101 determines whether the area type indicated in the identified VSC is the cropped image or the entire image. If the area type is not the cropped image, that is, if the area type is the entire image (NO in S603), the process goes to S604. If the area type is the cropped image (YES in S603), the process goes to S605.

In S604, the control unit 101 registers the position of the entire image as the preset position in association with Token of Preset. In S605, the control unit 101 registers the position of the cropped image as the preset position in association with Token of Preset. When the position of the entire image is registered as the preset position, the preset position is identified by the PTZ values. When the position of the cropped image is registered as the preset position, the preset position is identified by the PTZ values and the cropping position (relative position) in the image. The control unit 101 registers the area type in Preset with the preset position in S604 and S605.

There is a case in which the preset position has been registered in Preset specified in the SetPreset command received in S601. If the area type corresponding to the preset position that has been registered is equal to the area type of the preset position to be newly registered in this case, the control unit 101 updates the preset position that has been registered to the preset position that is newly registered. If the area type corresponding to the preset position that has been registered is different from the area type of the preset position to be newly registered, the control unit 101 additionally registers the new preset position in the same Preset. If the registration is normally completed in S604 or S605, in S606, the control unit 101 transmits the normal completion response to the client apparatus 200. The preset registration process is performed in the above manner.

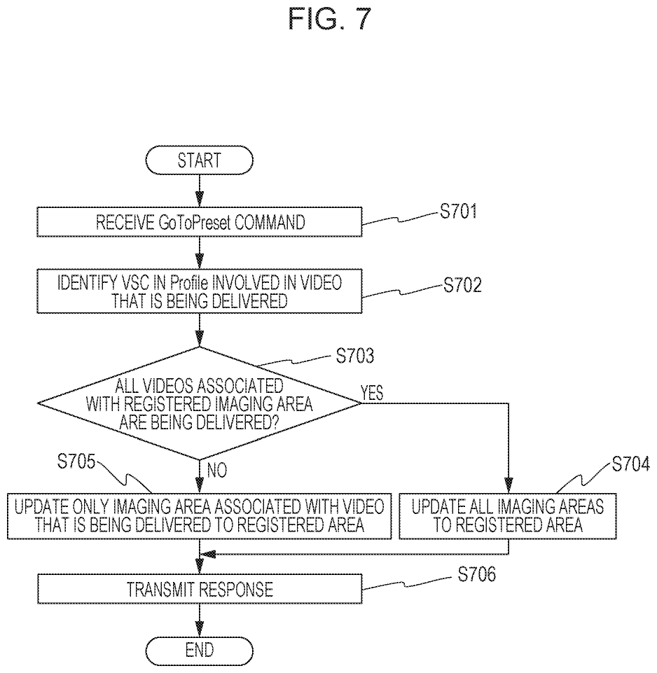

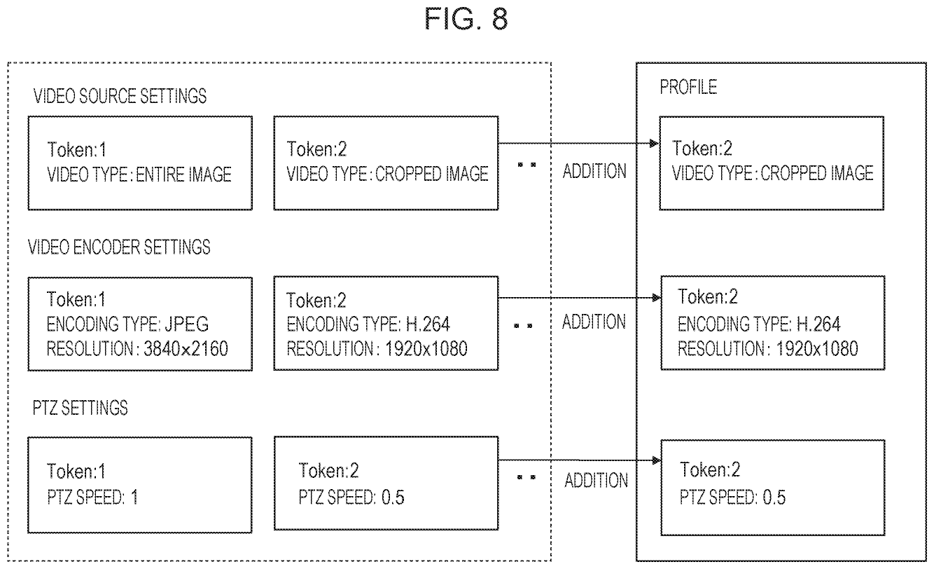

FIG. 7 is a flowchart illustrating a preset read-out process performed by the camera 100. The preset read-out process is a process to read out the preset position set in the preset registration process described above with reference to FIG. 6. Referring to FIG. 7, in S701, the control unit 101 in the camera 100 receives a GotoPreset command from the client apparatus 200. The GotoPreset command is a command to request reading out of the preset position registered using the SetPreset command described above and movement of the imaging area to the registered imaging area. In other words, the GotoPreset command is an example of a moving instruction to the preset position. The client apparatus 200 adds Token for identifying Preset indicating the preset position to be read out to the GotoPreset command and transmits the GotoPreset command to which Token is added to the camera 100.

In S702, the control unit 101 identifies Profile involved in a video that is being delivered at the timing of S702 and identifies VSC included in this Profile. In S703, the control unit 101 determines whether all the videos associated with the registered imaging area are being delivered based on the area type of VSC. If all the videos associated with the registered imaging area are being delivered (YES in S703), the process goes to S704. If at least part of the videos associated with the registered imaging area is not being delivered (NO in S703), the process goes to S705.

In S704, the control unit 101 reads out all the imaging areas. Then, the control unit 101 updates the position and the range of the imaging area at the timing of S704 to the those of the imaging area associated with Preset identified by Token of Preset added to the GotoPreset command. In S705, the control unit 101 reads out only the imaging area associated with the video that is being delivered at the timing of S705 and updates the position and the range of the imaging area at the timing of S705 to those of the imaging area that is read out. When no video is being delivered, the control unit 101 may update all the imaging areas. After S704 or S705, in S706, the control unit 101 stores the imaging area after the update in the storage unit 102 and transmits the normal completion response to the client apparatus 200.

As another example, the camera 100 may update all the imaging areas subjected to the preset registration without performing S703 when the GotoPreset command is received.

As described above, the camera 100 identifies the image to be registered based on the area type included in the profile in the preset registration process and determines the imaging area to be read out based on the area type that is being delivered in the preset read-out process. As described above, the user of the client apparatus 200 is capable of performing the preset registration process and the preset read-out process without being aware of the dependency relationship between the area type and the PTZ settings.

Accordingly, with the camera 100 according to the present embodiment, it is possible to provide the mechanism capable of adding appropriate settings to the profile without an awareness of the dependency relationship between the video source settings and the PTZ settings by the user.

Although the case is exemplified in the present embodiment, in which the camera 100 stores Profile associated with the entire image and Profile associated with the cropped image, the camera 100 may store multiple Profiles associated with the cropped image as another example. In addition, in this case, not only the area type but also information with which each image is capable of being identified are included in VSC of each Profile.

Although the preset target is the position of the image in the preset registration process and the preset read-out process described above, the preset target is not limited to this. As another example, the preset target may be an area (preset area) including the range supporting the zoom. Also in this case, the preset registration process and the preset read-out process are similar to those described above.

Although the embodiments of the present invention are described above in detail, the present invention is not limited to specific embodiments and various changes and modifications may be made to the invention without departing from the spirit and scope of the present invention described in the appended claims.

### Other Embodiments

The present invention is capable of being realized by a process in which the programs realizing one or more functions in the above embodiments is supplied to a system or an apparatus via a network or a storage medium and one or more processors in the computer of the system or the apparatus read out and execute the programs. In addition, the present invention is capable of being realized by a circuit (for example, an application specific integrated circuit (ASIC)) realizing one or more functions.

According to the respective embodiments described above, it is possible to add appropriate settings to the profile without an awareness of the dependency relationship between the video source settings and the PTZ settings by the user.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-227325, filed on Dec. 4, 2018, which is hereby incorporated by reference herein in its entirety.

What is claimed is:

1. An imaging apparatus comprising:
a storage unit configured to store a profile that is referred to in control of the imaging apparatus and that includes an area type of a captured image to be controlled;
a transmitting unit configured to transmit a setting value that is involved in a process to change an area of the captured image and that does not depend on a method for the changing process and an identifier for identifying the setting value to an external apparatus;
a receiving unit configured to receive an instruction to add the setting value to the profile with the identifier of the setting value from the external apparatus; and
an adding unit configured to add the setting value indicated in the adding instruction to the profile.

2. The imaging apparatus according to claim 1, further comprising:
a determining unit configured to determine, when an instruction to change the area for which the profile is specified is received, the method for the changing process based on the area type included in the profile involved in the changing instruction; and
a changing unit configured to perform the changing process using the method determined by the determining unit.

3. The imaging apparatus according to claim 2,
wherein the determining unit determines a first method to be the method for the changing process when the area type indicated in the profile involved in the changing instruction is an entire image and determines a second method to be the method for the changing process when the area type indicated in the profile involved in the changing instruction is a cropped image, at least one driver, among pan, tilt, and zoom drivers, being driven to change at least one of a position and a range of the area in the first method, at least one of the position and the range of the area being changed through digital processing in the second method.

4. The imaging apparatus according to claim 1, further comprising:
a first identifying unit configured to identify, when a request to acquire a position of the area for which the profile is specified is received, the position of the area based on the area type included in the profile involved in the acquiring request,
wherein the transmitting unit transmits the position identified by the first identifying unit to the external apparatus.

5. The imaging apparatus according to claim 1, further comprising:
a second identifying unit configured to identify, when an instruction to register a preset position of the area for which the profile is specified is received, an area to be registered based on the area type included in the profile involved in the registering instruction; and
a registering unit configured to register the preset position of the area identified by the second identifying unit.

6. The imaging apparatus according to claim 5,
wherein the registering instruction includes a preset identifier, and
wherein the registering unit registers the preset position in association with the preset identifier.

7. The imaging apparatus according to claim 6,
wherein, when the instruction to register a plurality of preset positions for one preset identifier is received, the registering unit registers the plurality of preset positions in association with the one preset identifier.

8. The imaging apparatus according to claim 6, further comprising:
a moving unit configured to move the area corresponding to the profile stored in the storage unit to the preset position associated with the preset identifier when a moving instruction to the preset position for which the preset identifier is specified is received.

9. The imaging apparatus according to claim 8,
wherein the area that is being delivered is moved to the preset position corresponding to the preset identifier at a timing when the moving instruction is received.

10. A control method performed by an imaging apparatus, the control method comprising:
transmitting a setting value that is involved in a process to change an area of a captured image and that does not depend on a method for the changing process and an identifier for identifying the setting value to an external apparatus;
receiving an instruction to add the setting value to a profile that is referred to in control of the imaging apparatus with the identifier of the setting value from the external apparatus; and
adding the setting value indicated in the adding instruction to the profile that is stored in a storage unit and that includes an area type of the captured image to be controlled.

11. The control method according to claim 10, further comprising:
determining, when an instruction to change the area for which the profile is specified is received, the method for the changing process based on the area type included in the profile involved in the changing instruction; and
performing the changing process using the determined method.

12. The control method according to claim 11,
wherein the determining determines a first method to be the method for the changing process when the area type indicated in the profile involved in the changing instruction is an entire image and determines a second method to be the method for the changing process when the area type indicated in the profile involved in the changing instruction is a cropped image, at least one driver, among pan, tilt, and zoom drivers, being driven to change at least one of a position and a range of the area in the first method, at least one of the position and the range of the area being changed through digital processing in the second method.

13. The control method according to claim 10, further comprising:
identifying, when a request to acquire a position of the area for which the profile is specified is received, the position of the area based on the area type included in the profile involved in the acquiring request,
wherein the transmitting transmits the identified position to the external apparatus.

14. The control method according to claim 10, further comprising:
identifying, when an instruction to register a preset position of the area for which the profile is specified is received, an area to be registered based on the area type included in the profile involved in the registering instruction; and
registering the preset position of the identified area.

15. The control method according to claim 14,
wherein the registering instruction includes a preset identifier, and
wherein the registering registers the preset position in association with the preset identifier,

16. The control method according to claim 15,
wherein, when the instruction to register a plurality of preset positions for one preset identifier is received, the registering registers the plurality of preset positions in association with the one preset identifier.

17. The control method according to claim 15, further comprising:
moving the area corresponding to the profile stored in the storage unit to the preset position associated with the preset identifier when a moving instruction to the preset position for which the preset identifier is specified is received.

18. The control method according to claim 17,
wherein the area that is being delivered is moved to the preset position corresponding to the preset identifier at a timing when the moving instruction is received.

19. A computer-readable non-transitory recording medium storing a program causing a computer of an imaging apparatus to function as:
a transmitting unit configured to transmit a setting value that is involved in a process to change an area of a captured image and that does not depend on a method for the changing process and an identifier for identifying the setting value to an external apparatus;
a receiving unit configured to receive an instruction to add the setting value to a profile that is referred to in control of the imaging apparatus with the identifier of the setting value from the external apparatus; and
an adding unit configured to add the setting value indicated in the adding instruction to the profile that is stored in a storage unit and that includes an area type of the captured image to be controlled.
